(19) United States
(12) Patent Application Publication
(10) Pub. No.: US 2026/0269296 A1
(43) Pub. Date: Sep. 10, 2026

(54) METAL-SUPPORTED SOLID OXIDE CELLS

(71) Applicant: University of Connecticut, Farmington, CT (US)

(72) Inventors: Xiao-Dong Zhou, Willington, CT (US); Nengneng Xu, Vernon, CT (US); Yudong Wang, Willimantic, CT (US); Zizhou He, Willimantic, CT (US)

(21) Appl. No.: 19/557,376

(22) Filed: Mar. 5, 2026

Related U.S. Application Data
(60) Provisional application No. 63/767,665, filed on Mar. 6, 2025.

(51) Int. Cl. H01M 8/1253; H01M 4/86; H01M 4/90; H01M 8/12

(52) U.S. Cl. CPC H01M 8/1253; H01M 4/9033; H01M 2004/8689; H01M 2008/1293

(57) ABSTRACT

The present disclosure describes metal-supported solid oxide electrochemical cells (MS-SOCs), including a ceramic electrochemical assembly interposed between porous electrode structures, an unsintered, porous metallic support, and an electrically conductive bonding layer. The ultra-thin ceramic electrochemical assembly can include an electrolyte layer. The electrolyte layer can have a thickness of 0.1 micrometer to 10 micrometers. The present disclosure also describes applications in fuel cell stacks, portable power generators, and hybrid energy systems, and methods of fabrication and use.

### CROSS REFERENCE TO RELATED APPLICATION

This application claims the benefit of and priority to U.S. Patent Application No. 63/767,665, filed Mar. 6, 2025, the contents of which are incorporated by reference herein in their entirety.

### STATEMENT REGARDING FEDERALLY SPONSORED RESEARCH

This invention was made with government support under DE-AR0001774 awarded by the U.S. Department of Energy. The government has certain rights in the invention.

### BACKGROUND OF THE INVENTION

### 1. Field of the Invention

The present disclosure relates to metal-supported solid oxide cells, for example, ultra-thin metal-supported solid oxide cells such as an ultra-thin metal-supported solid oxide fuel cell.

### 2. Description of the Related Art

Solid oxide cells (SOCs) offer an efficient and high-energy-density solution for electrochemical energy storage. These devices use solid-state ionic conductors to enable charge storage and release through oxidation/reduction (redox) reactions. Unlike conventional lithium-ion batteries, SOESCs benefit from high-temperature operation, which facilitates rapid ionic transport and enhances electrode kinetics.

Current fabrication techniques for SOCs involve multiple high-temperature sintering steps, which are necessary to achieve dense electrolyte structures while maintaining porous electrodes for gas-phase reactant diffusion. Conventional methods, such as tape casting, screen printing, and physical vapor deposition, introduce complications due to material incompatibility, thermal expansion mismatches, and residual stresses that lead to mechanical failure. Furthermore, high-temperature sintering can induce grain growth, which reduces the density of grain boundaries that contribute to ionic conduction, thereby diminishing overall cell performance. These fabrication challenges limit the scalability and cost-effectiveness of SOCs. The form factor of SOCs significantly affects their applicability in various energy storage and power delivery systems. Conventional SOCs are bulky and rigid, restricting integration into compact or flexible electronic devices. The development of ultra-thin SOCs presents a significant advancement by reducing ohmic losses associated with thick electrolytes and improving power density. Ultra-thin configurations enable lower operating temperatures, minimizing degradation mechanisms and enhancing long-term stability. Additionally, thin-film SOCs facilitate novel device architectures, including flexible and stacked configurations, which improve volumetric energy density and expand potential applications in portable and embedded energy systems.

To overcome current fabrication challenges, advancements in thin-film deposition techniques, such as atomic layer deposition and pulsed laser deposition, make it desirable to achieve precise control over material thickness and composition. Integration of nanostructured materials can further enhance ionic conductivity and mechanical resilience, addressing issues related to thermal expansion mismatches. The optimization of processing conditions to reduce sintering temperatures while maintaining structural integrity is crucial for the widespread adoption of SOCs. Improved fabrication methods will enable the realization of ultra-thin SOCs with enhanced efficiency, durability, and application versatility.

Accordingly, what the industry needs is improved technology to permit a lighter and smaller footprint for solid oxide cells, increasing their versatility and adaptability into various articles of manufacture and especially into portable devices requiring power to operate.

### SUMMARY

Metal-supported solid oxide cells (MS-SOCs) present a promising alternative to conventional ceramic-based designs. These structures utilize a porous metal support, which provides mechanical strength and allows for the use of thinner electrolyte layers, reducing ohmic losses and enabling lower operating temperatures. Additionally, MS-SOCs mitigate thermal expansion mismatches by offering better compatibility between metal and ceramic layers. The use of metal supports also enhances the thermal shock resistance and overall durability of the cells, making them suitable for dynamic operation in energy storage applications. However, challenges such as oxidation of metal supports, diffusion of metal species into electrolyte layers, and fabrication complexities still need to be addressed for widespread implementation.

In one aspect, the present disclosure provides a metal-supported solid oxide electrochemical cell including an ultra-thin ceramic electrochemical assembly disposed between porous electrode structures; an unsintered, porous metallic support; and an electrically conductive bonding layer interposed between the unsintered porous metallic support and the ultra-thin ceramic electrochemical assembly. The ultra-thin ceramic electrochemical assembly can include an electrolyte layer. The electrolyte layer can have a thickness of 0.1 micrometer to 10 micrometers.

In another aspect, the present disclosure provides methods of making the metal-supported solid oxide electrochemical cells described herein. In certain embodiments, the methods include preparing slurries of an electrolyte layer, an anode active layer, and an anode supporting layer using Resonant Acoustic Mixing® (RAM), followed by sequential layer casting onto a carrier. A two-step sintering process follows that can achieve controlled shrinkage and final density. In some embodiments, a barrier layer is screen-printed onto the sintered electrolyte surface and fired, followed by screen-printing and sintering of a cathode layer and a current collector layer. In particular embodiments, a metal-based binder is applied to the unsintered, porous metallic support before positioning the pre-fabricated, ultra-thin ceramic electrochemical assembly to complete the MS-SOC.

In yet another aspect, the present disclosure provides methods of using the MS-SOCs. In some embodiments, the methods include flowing an electrical current through the ultra-thin ceramic electrochemical assembly, with the anode supplied with humidified hydrogen and the cathode fed with air. In particular embodiments, the ultra-thin configuration and robust mechanical strength of the cells facilitate their use in compact, lightweight, and portable applications, overcoming the limitations of conventional fabrication techniques and cell architectures. In certain embodiments, the cells are integrated into devices selected from fuel cell stacks, portable power generators, aviation power systems, maritime propulsion systems, data center backup power systems, and hybrid energy systems.

These and other features will be more clearly understood from the following drawings, detailed description and example as well as the appended claims.

### BRIEF DESCRIPTION OF THE DRAWINGS

The features and advantages of the present disclosure will be apparent from the following description taken in conjunction with the accompanying drawings.

FIG. 1A is a schematic diagram depicting a cross-section of an embodiment of a metal-supported solid oxide cell (MS-SOC) of the present disclosure.

FIG. 1B is a schematic diagram of a solid oxide fuel cell including an embodiment of an MS-SOC in the SOC Stack.

FIG. 2 is a series of scanning electron microscope (SEM) images of cross-sections of a MS-SOC of the present disclosure, for example, as shown in FIG. 1.

FIG. 3 is a graph depicting voltage versus current performance of an embodiment of a MS-SOC as a function of different operating temperatures (700° C., 750° C., and 800° C.), where the cathode air flow was 600 sccm, and the anode hydrogen flow was 200 sccm.

FIG. 4 is a graph depicting electrochemical impedance spectroscopy (EIS) at open circuit voltage (OCV) of an embodiment of a MS-SOC at 750° C. and 800° C., where the cathode air flow was 600 sccm, and the anode hydrogen flow was 200 sccm.

FIG. 5 is a graph depicting EIS at 0.5 A cm⁻² of an embodiment of a MS-SOC at 750° C. and 800° C., where the cathode air flow was 600 sccm, and the anode hydrogen flow was 200 sccm.

### DETAILED DESCRIPTION OF THE INVENTION

Disclosed herein are metal-supported solid oxide electrochemical cells (MS-SOCs) and methods of fabrication. In some embodiments, an ultra-thin ceramic electrochemical assembly is formed prior to attachment of a porous metallic support. This fabrication sequence reduces thermal mismatch constraints associated with co-sintering of ceramic and metallic components and supports controlled shrinkage of the ceramic structure. The resulting MS-SOC structure supports formation of electrolyte layers in the micrometer-scale thickness range while maintaining mechanical strength through the porous metallic support. The disclosed methods also enable reproducible layer formation, reduced processing time, and compatibility with scalable manufacturing processes.

Compared with conventional techniques for fabrication of co-sintered metal-supported solid oxide cells, the technology disclosed herein reduces processing complexity by forming the ceramic electrochemical assembly prior to integration of the porous metallic support. This fabrication sequence reduces the effects of thermal expansion mismatch that commonly arise during high-temperature co-sintering of metal and ceramic components. The use of ultra-thin electrolyte layers reduces ohmic resistance and mass transport losses relative to thicker electrolyte structures. Controlled slurry preparation and sequential layer formation promote uniform microstructure development and dimensional stability of the ceramic assembly. These features collectively support improved electrochemical performance, manufacturing yield, and scalability when compared with conventional fabrication routes.

Metal-supported solid oxide electrochemical cells formed using this technology may be deployed in a variety of energy conversion and energy storage environments. In some embodiments, the cells are incorporated into fuel cell stacks for stationary power generation or distributed backup power systems. In some embodiments, the cells are integrated into portable power generators or auxiliary power units that benefit from reduced weight and compact form factor. In further embodiments, the cells are incorporated into transportation-related power systems, including aviation power modules, maritime propulsion support systems, and hybrid energy platforms. In still further embodiments, the cells are deployed in data center backup systems, wireless sensor nodes, or compact electronic platforms that benefit from high power density and reduced footprint. Operating conditions and structural configurations may be selected according to requirements of a target application.

As an introduction, the present disclosure provides a metal-supported solid oxide electrochemical cell including an ultra-thin ceramic electrochemical assembly disposed between porous electrode structures. The MS-SOC includes an unsintered, porous metallic support, and an electrically conductive bonding layer interposed between the unsintered, porous metallic support and the ultra-thin ceramic electrochemical assembly. The ultra-thin ceramic electrochemical assembly can include an electrolyte layer. The electrolyte layer can have a thickness of 0.1 micrometer to 10 micrometers.

The present disclosure also provides a new process for the rapid production of MS-SOCs such as ultra-thin (i.e., the thickness of the ceramic electrochemical assembly is 250 micrometers or less) MS-SOCs, which can meet the needs of large-scale SOC production companies. The disclosed process saves production time and solves the problem of difficult sintering of metal-supports and ceramics.

Prior art methods for fabricating MS-SOCs include: (i) preparing the metal support layer and the electrolyte layer, respectively; (ii) using isostatic pressing to compress the metal support layer-electrolyte layer-metal support layer into a sandwich structure, followed by sintering to form the MS-SOC support substrate; (iii) infiltrating anode and cathode materials onto both sides of the MS-SOC support substrate; and (iv) performing a final sintering to produce the MS-SOC. This approach is time-intensive and easily results in poor uniformity of the active materials on the anode and cathode. Moreover, achieving successful sintering of the metal support body and the electrolyte layer together is particularly difficult, thus resulting in lower yield and performance than desired.

Advantageously, the preparation process disclosed herein can significantly shorten the processing time and result in consistent performing product. Among other things, the techniques employ a novel approach of fabricating the ceramic electrochemical cell assembly first and subsequently adding the metal support. This method addresses challenges associated with sintering MS-SOCs in a high-temperature reducing atmosphere, thereby streamlining the production process and lowering manufacturing costs. Additionally, the new process enables the production of ultra-thin electrolyte and ceramic layers, resulting in enhanced cell performance.

The technology prepares an ultra-thin ceramic layer with a thickness of, for example, only 100 micrometers, of which the electrolyte layer may be only 3 micrometers thick. The ultra-thin, porous ceramic layer and the dense electrolyte significantly reduce the mass transfer resistance and ohmic resistance of the MS-SOC, respectively. In addition, the method adopts post-positioning the metal support to avoid the problem of the metal support's conductivity decreasing due to high-temperature sintering. The metal support substrate can be successfully prepared by mechanical processing of metal sheets such as stainless steel, further reducing the production cost.

The metal-supported solid oxide electrochemical cell described herein is constructed as a multi-layered assembly, each layer serving a distinct function serving electrochemical performance, mechanical durability, and manufacturability. The ultra-thin ceramic electrochemical assembly includes a dense electrolyte layer composed primarily of, for example, yttria-stabilized zirconia. This electrolyte layer acts as the ionic conductor, facilitating oxygen ion transport. The thickness of the dense yttria-stabilized zirconia electrolyte layer broadly ranges from two micrometers to ten micrometers, with a preferred thickness of three to five micrometers. This thickness may be selected to reduce ohmic resistance while maintaining structural integrity.

In certain embodiments, a Pr_{0.1}Gd_{0.1}Ce_{0.8}O_{1.9-δ} barrier layer is disposed on the dense electrolyte layer. The barrier layer is screen-printed and sintered at twelve hundred degrees Celsius for three hours, and the barrier layer functions to prevent undesirable chemical interactions between the electrolyte layer and the cathode layer. The cathode layer is then deposited on the barrier layer and is composed of a perovskite-type oxide, such as samarium strontium cobaltite combined with gadolinia-doped ceria. Alternative cathode compositions include lanthanum strontium manganite or lanthanum strontium cobalt ferrite. The cathode layer is also screen-printed and sintered at one thousand degrees Celsius for two hours.

The MS-SOC further includes electrode structures. The electrode structures can be porous. The electrode structures include an anode (active) layer and a cathode layer. The anode layer can be adjacent to an anode support layer. The anode support layer can be composed of nickel oxide and a ceramic oxide, such as yttria-stabilized zirconia, which is selected to match the coefficient of thermal expansion of the electrolyte layer. This layer provides mechanical support and facilitates the diffusion of gas-phase reactants. An anode active layer is positioned on the anode support layer to enhance electrochemical reactions. In some embodiments, a current collector composed of gadolinia-doped ceria or lanthanum strontium cobaltite is screen-printed onto the cathode layer to improve electrical conductivity.

Mechanical strength and thermal shock resistance may be provided by a porous metallic support fabricated from stainless steel. The thickness of the metallic support ranges broadly from fifty micrometers to two hundred micrometers, with a preferred range of one hundred micrometers to one hundred sixty micrometers. An electrically conductive bonding layer, typically a nickel-based binder, is applied between the unsintered, porous metallic support and the ultra-thin ceramic electrochemical assembly to ensure robust electrical and mechanical bonding.

The total thickness of the ultra-thin ceramic electrochemical assembly ranges from 50 micrometers to 250 micrometers, with a preferred range of 100 micrometers to 175 micrometers. This configuration reduces mass transfer resistance and enhances power density, enabling the cell to achieve performance metrics such as a power density greater than one point five watts per square centimeter at zero point nine volts.

Alternative embodiments are contemplated. For example, the barrier layer may be omitted in applications where chemical compatibility between the electrolyte and cathode is not a concern. The cathode layer composition may be varied to include other perovskite-type oxides, such as barium strontium cobalt ferrite, depending on the operating conditions and desired performance characteristics. The metallic support may be fabricated from alternative materials, such as nickel-based alloys, to further enhance thermal compatibility and reduce oxidation risks. The bonding layer may incorporate alternative conductive materials, such as silver-based or cobalt-based binders, to tailor electrical conductivity and mechanical adhesion properties.

Selecting perovskite-type oxides for the cathode layer provides high electronic and ionic conductivity, enabling efficient oxygen reduction reactions and enhancing power density. The Ni/YSZ anode structure combines high ionic conductivity with excellent catalytic activity for fuel oxidation, improving electrochemical performance and fuel utilization. The Sm_{0.5}Sr_{0.5}CO_{O3-δ} (SSC-GDC) cathode composition offers superior oxygen reduction kinetics and thermal stability, ensuring high performance and durability.

Applying a screen-printed gadolinia-doped ceria (LSC) current collector on the cathode provides efficient electron collection and distribution, reducing electrical losses and enhancing overall performance. Specifying the total thickness of the ultra-thin ceramic electrochemical assembly in the range of 50 to 200 micrometers, or 100 to 160 micrometers, minimizes material usage while maintaining structural integrity and high electrochemical performance, enabling integration into portable and space-constrained applications.

Defining the porous metallic support thickness in the range of 50 to 200 micrometers ensures adequate mechanical support while maintaining a lightweight design, facilitating scalability and adaptability to various device architectures. Achieving a power density greater than 1.5 W/cm² at 0.9 V demonstrates the efficiency and performance of the cell, making the cell suitable for demanding energy applications.

Integrating the metal-supported solid oxide electrochemical cell into devices enables the development and implementation of advanced energy systems with high efficiency, compact form factors, and enhanced reliability. Application in diverse systems, including fuel cell stacks, portable power generators, and hybrid energy systems, demonstrates the versatility and adaptability of the cell to various industries and addresses the growing demand for efficient and sustainable energy solutions.

As used herein, an “ultra-thin ceramic electrochemical assembly” generally refers to a layered structure including ceramic materials, including an electrolyte and optional barrier and electrode layers, with a total thickness of 25 micrometers to 250 micrometers, designed for electrochemical energy storage or conversion.

As used herein, “yttria-stabilized zirconia” or “YSZ” generally refers to a ceramic material composed mainly of zirconium dioxide (ZrO₂) stabilized with yttrium oxide (Y₂O₃), utilized as an electrolyte in solid oxide cells because of the material's elevated ionic conductivity and chemical stability.

As used herein, a “barrier layer” generally refers to a protective layer such as a ceramic oxide layer with a composition of metal oxides, used to prevent interfacial reactions and enhance ionic conductivity in SOCs.

As used herein, a “metal-based binder” generally refers to an electrically conductive bonding material containing a metal as the primary component, used to adhere ceramic assemblies to metallic supports in solid oxide cells.

As used herein, a “perovskite-type oxide” generally refers to an oxide material characterized by a crystal structure resembling the mineral perovskite (ABO₃), frequently utilized as an electrode in solid oxide cells due to the material's mixed ionic and electronic conductivity.

As used herein, “lanthanum strontium manganite” generally refers to a perovskite-type oxide with the nominal composition La₁₋ₓSrₓMnO₃, used as a cathode material in solid oxide cells.

As used herein, “lanthanum strontium cobalt ferrite” generally refers to a perovskite-type oxide with the nominal composition La₁₋ₓSrₓCo_{1-y}Fe_{y}O₃, used as a cathode material in solid oxide cells.

As used herein, “barium strontium cobalt ferrite” generally refers to a perovskite-type oxide with the nominal composition Ba₁₋ₓSrₓCo_{1-y}Fe_{y}O₃, used as a cathode material in solid oxide cells.

As used herein, a “Ni/YSZ anode” generally refers to an anode structure composed of a combination of nickel and yttria-stabilized zirconia, utilized for catalytic activity and ionic/electronic conductivity in solid oxide cells.

As used herein, “Sm_{0.5}Sr_{0.5}CO_{O3-δ}” or “samarium strontium cobaltite” generally refers to a perovskite-type oxide with the nominal composition Sm_{0.5}Sr_{0.5}CoO_{3-δ}, where δ represents oxygen deficiency, used as a cathode material in solid oxide cells.

As used herein, “Gd_{0.1}Ce_{0.9}O_{2-δ}” or “gadolinia-doped ceria” generally refers to a ceramic oxide with the nominal composition Gd_{0.1}Ce_{0.9}O_{2-δ}, where δ represents oxygen deficiency, used as an electrode or current collector material in solid oxide cells.

As used herein, a “screen-printed current collector” generally refers to a current collector layer formed by screen printing a paste containing a ceramic oxide, used to facilitate electrical contact with the cathode in solid oxide cells.

As used herein, a “coefficient of thermal expansion” generally refers to a material property describing the rate at which a material expands or contracts with changes in temperature, typically expressed in units of per degree Celsius (° C.⁻¹).

As used herein, “power density greater than 1.5 W/cm² at 0.9 V” generally refers to an operational parameter indicating that the solid oxide cell is capable of delivering a power output exceeding 1.5 watts per square centimeter of active area when operated at a voltage of 0.9 volts.

As used herein, “plasticizer” generally refers to a substance added to a mixture to enhance flexibility and decrease brittleness, thereby aiding the casting process. A plasticizer can be a fugitive plasticizer, meaning that it is burned out during the sintering process so that it is not present in the final solid sintered electrode product.

As used herein, “binder” generally refers to a material used to hold particles together in a mixture, providing structural integrity during processing. A binder can be a fugitive binder, meaning that it is burned out during the sintering process so that it is not present in the final solid sintered electrode product.

As used herein, “slurry” generally refers to a semi-liquid mixture of solid particles, often suspended in a liquid, used as an intermediate material in the fabrication process.

As used herein, “de-gassing” generally refers to the process of removing trapped air or gas bubbles from a liquid or slurry, and can be undertaken to ensure uniformity and prevent defects in the final product.

As used herein, “casting” generally refers to a manufacturing process in which a liquid or slurry is poured into a mold or onto a surface to form a solid layer upon drying or curing.

As used herein, “electrolyte layer” generally refers to a layer of electrolyte material that conducts ions, i.e., protons or H+s, and oxygen ions or O2-s, serving as a central component of a solid oxide cell.

As used herein, a “thin electrolyte layer” generally refers to a layer of electrolyte material between about 10 micrometers and about 25 micrometers in thickness, for example, between about 8 micrometers and about 25 micrometers in thickness. A thin electrolyte layer conducts ions, serving as a central component of a solid oxide cell.

As used herein, an “ultra-thin electrolyte layer” generally refers to a layer of electrolyte material between about 1 micrometers to about 10 micrometers in thickness. An ultra-thin electrolyte layer conducts ions, serving as a central component of a solid oxide cell.

As used herein, “anode particulate” or “anode particulate material” generally refers to a powdered anode material used to form the anode layer, which facilitates the oxidation reaction in a solid oxide cell.

As used herein, “anode layer” generally refers to a layer of material adjacent to the electrolyte layer, responsible for the electrochemical oxidation reaction in the solid oxide cell.

As used herein, “anode support particulate” or “anode support particulate material” generally refers to a powdered anode support material used to form the anode support layer, providing structural support to the anode layer.

As used herein, “anode support layer” generally refers to a layer adjacent to the anode layer, designed to provide mechanical stability and support to the solid oxide cell structure.

As used herein, “three-layered anode supported anode-electrolyte structure” generally refers to a composite structure that includes an electrolyte layer, an anode layer, and an anode support layer, forming a structural component of the solid oxide cell.

As used herein, “sintering” generally refers to a thermal process that involves heating a material to a temperature below the material's melting point to bond particles together, thereby enhancing strength and density.

As used herein, “cathode particulate” or “cathode particulate material” generally refers to a powdered cathode material used to form the cathode layer, which facilitates the reduction reaction in a solid oxide cell.

As used herein, “cathode layer” generally refers to a layer applied to the barrier layer, responsible for the reduction reaction in the solid oxide cell.

As used herein, “ceramic” generally refers to an inorganic, non-metallic solid formed from a composition that includes metal oxides, metal nitrides, metal carbides, or metal oxynitrides. A ceramic forms by heating the composition to a temperature sufficient to cause densification, grain growth, or solid-state bonding of particulate material. A ceramic exhibits ionic or electronic conductivity, thermal stability, and mechanical rigidity under elevated-temperature operating conditions associated with solid oxide cells. Generally, ceramics do not exhibit carbon-hydrogen bonds, do not exhibit free-electron conduction like metals, have high melting points, exhibit hardness and brittleness and are chemically stable at high temperatures. Some non-limiting examples include zirconia (ZrO₂), yttria-stabilized zirconia (YSZ), ceria (CeO₂), alumina (Al₂O₃) and perovskites (LSM, LSCF, BSCF, etc.).

As used herein, “sintered ceramic” generally refers to a solid inorganic material formed by heating a particulate ceramic composition to a temperature below the melting point of the composition to cause bonding of adjacent particulates through solid-state diffusion. A sintered ceramic exhibits a continuous grain structure, mechanical rigidity, and thermal stability under the elevated-temperature conditions associated with solid oxide cell operation. A sintered ceramic can include residual porosity or can form as a dense structure depending on the processing temperature and the particulate composition.

As used herein, “dense ceramic electrolyte” generally refers to a ceramic layer that exhibits a continuous, non-porous structure that supports ionic transport at elevated temperature. A dense ceramic electrolyte includes a sintered ceramic material that defines substantially no interconnected porosity through the thickness of the layer. A dense ceramic electrolyte maintains gas separation between adjacent electrode layers in a solid oxide cell and provides a continuous path for oxygen-ion conduction or proton conduction depending on the ceramic composition.

As used herein, “solid oxide cell” (“SOC”) generally refers to an electrochemical structure that generates an electrical output or a chemical output through reactions that occur across a solid electrolyte. The structure includes a solid electrolyte between an anode layer and a cathode layer. The electrolyte can be ceramic. The structure operates at an elevated temperature and enables ionic transport through the solid electrolyte without use of a liquid phase.

As an example, a solid oxide cell can include a zirconia-based ceramic electrolyte between a nickel-containing anode layer and a lanthanum-strontium-manganite cathode layer. The example generates an electrical current when a fuel stream contacts the anode layer and when an oxidizer stream contacts the cathode layer. Other examples include structures with a scandia-stabilized zirconia electrolyte, a ceria-based electrolyte, a cobaltite-based cathode, or a perovskite-based anode. Each structure includes a solid ceramic electrolyte between an anode layer and a cathode layer and operates at an elevated temperature that enables ionic transport.

In another example, the ultra-thin ceramic electrochemical assembly includes a dense yttria-stabilized zirconia (YSZ) electrolyte layer with a thickness in the range of 2 micrometers to 10 micrometers. In certain embodiments, the ultra-thin ceramic electrochemical assembly further includes a barrier layer comprising praseodymium, gadolinium, and ceria, for example, a Pr_{0.1}Gd_{0.1}Ce_{0.8}O_{1.9-δ} barrier layer disposed on the dense YSZ electrolyte layer. Here, δ represents the oxygen non-stoichiometry associated with oxygen vacancy formation in the ceria-based oxide. The value of δ depends on factors including temperature and oxygen partial pressure. The oxygen deficiency (δ) may be determined by conventional techniques for measuring oxygen non-stoichiometry, including thermogravimetric analysis or other equivalent methods known in the art. In particular embodiments, the unsintered, porous metallic support includes a stainless steel sheet fabricated into a porous structure, and the electrically conductive bonding layer includes a nickel-based binder. In some embodiments, the porous electrode structures include an anode support layer and a cathode layer disposed on opposite sides of the ultra-thin ceramic electrochemical assembly. The cathode layer can include a perovskite-type oxide selected from lanthanum strontium manganite, lanthanum strontium cobalt ferrite, and barium strontium cobalt ferrite.

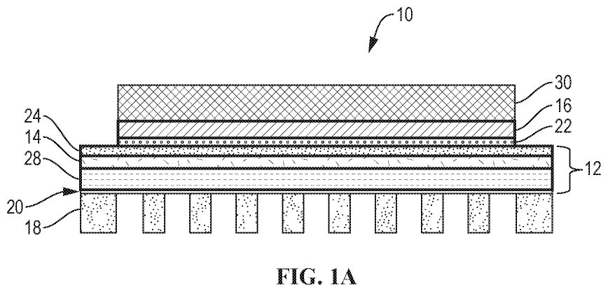

Referring to FIG. 1, a schematic of an embodiment of a MS-SOC is depicted. The metal-supported solid oxide electrochemical cell 10, featuring a ceramic electrochemical assembly 12 positioned between an anode layer 14 and a cathode layer 16. The ceramic electrochemical assembly 12 includes an electrolyte layer 24 and a barrier layer 22, both of which contribute to ionic conduction and chemical stability. The anode layer 14 is supported by a porous anode support layer 28, while the cathode layer 16 is coupled to a current collector 30. An electrically conductive bonding layer 20 connects the ceramic electrochemical assembly 12 to an unsintered, porous metallic support 18, providing both mechanical strength and electrical connectivity. This arrangement facilitates effective electrochemical performance and reliable structural integrity within the cell.

In various embodiments, the metal-supported solid oxide electrochemical cell includes an ultra-thin ceramic electrochemical assembly disposed between porous electrode structures, a porous metallic support, and an electrically conductive bonding layer interposed between the porous metallic support and the ultra-thin ceramic electrochemical assembly.

In some embodiments, the ultra-thin ceramic electrochemical assembly includes an electrolyte layer such as a yttria-stabilized zirconia (YSZ) electrolyte layer. In certain embodiments, the thickness of the electrolyte layer is between 0.1 micrometers and 10 micrometers. In some embodiments, the electrolyte layer can have a thickness less than or equal to 50 micrometers, for example, less than or equal to 45 micrometers, less than or equal to 40 micrometers, less than or equal to 35 micrometers, or less than or equal to 30 micrometers. In some embodiments, the electrolyte layer can have a thickness less than or equal to 25 micrometers, for example, less than or equal to 20 micrometers, less than or equal to 15 micrometers, less than or equal to 10 micrometers. In particular embodiments, the electrolyte layer can be about 10 micrometers, or less than or equal to 9 micrometers, less than or equal to 8 micrometers, less than or equal to 7 micrometers, less than or equal to 6 micrometers, less than or equal to 5 micrometers, less than or equal to 4 micrometers, less than or equal to 3 micrometers, less than or equal to 2 micrometers, or less than or equal to 1 micrometer. In each of these examples with upper limits, the lower limit for the thickness of an electrolyte layer, such as an electrolyte layer, is at least about 0.1 micrometers, or at least about 0.3 micrometers, or at least about 0.5 micrometers

In some embodiments, the electrolyte layer can have a thickness between 1 micrometer and 10 micrometers, such as 1 micrometer to 10 micrometers, 2 micrometers to 9 micrometers, 3 micrometers to 8 micrometers, 4 micrometers to 7 micrometers, 5 micrometers to 6 micrometers, or even more narrowly defined ranges such as 2 micrometers to 4 micrometers, 3 micrometers to 5 micrometers, 4 micrometers to 6 micrometers, 5 micrometers to 7 micrometers, 6 micrometers to 8 micrometers, 7 micrometers to 9 micrometers, and 8 micrometers to 10 micrometers. In further embodiments, the thickness of the electrolyte layer can be specified in one micrometer intervals, for example, 1 micrometer to 2 micrometers, 2 micrometers to 3 micrometers, 3 micrometers to 4 micrometers, 4 micrometers to 5 micrometers, 5 micrometers to 6 micrometers, 6 micrometers to 7 micrometers, 7 micrometers to 8 micrometers, 8 micrometers to 9 micrometers, and 9 micrometers to 10 micrometers. The thickness of an electrolyte layer can be determined by scanning electron microscopy (SEM) or profilometry.

The electrolytes of the present disclosure can include a thin electrolyte layer, which can be an ultra-thin electrolyte layer. The electrolyte particulates can be formed using metal oxide solid solution including one or more metal oxides selected from gadolinium (Gd) oxide, cerium (Ce) oxide, yttrium (Y) oxide, scandium (Sc) oxide, zirconium (Zr) oxide, hafnium (Hf) oxide, niobium (Nb) oxide, tantalum (Ta) oxide, calcium (Ca) oxide, strontium (Sr) oxide, barium (Ba) oxide, praseodymium (Pr) oxide, neodymium (Nd) oxide, samarium (Sm) oxide, europium (Eu) oxide, gadolinium (Gd) oxide, terbium (Tb) oxide, dysprosium (Dy), holmium (Ho) oxide, erbium (Er) oxide, thulium (Tm) oxide, and ytterbium (Yb) oxide. In various embodiments, an electrolyte can include two metal oxides, two or more metal oxides, three metal oxides, three or more metal oxides, four metal oxides, four or more metal oxides, five metal oxides, or five or more metal oxides from this list. In some embodiments, the electrolyte includes yttria-stabilized zirconia (YSZ) particulates. In certain embodiments, the electrolyte layer includes gadolinium-doped ceria (GDC) particulates. In particular embodiments, the electrolyte layer includes samarium-doped ceria or scandium-stabilized zirconia. In some embodiments, the electrolyte layer includes yttrium doped barium cerate-zirconate (BCZY). In certain embodiments, the electrolyte layer includes yttrium and ytterbium doped barium cerate-zirconate (BCZYYb).

In various embodiments, an ultra-thin electrolyte layer can be an acoustic energy slurry-formed electrolyte layer. Using acoustic energy on the slurry of metal oxides, plasticizer, binder, and pore former, when present, can facilitate uniform dispersion and casting of the particulates, resulting in a more uniform and evenly dispersed material for better performance.

In various embodiments, the electrolyte layer can be integrated into a multi-layer solid oxide cell structure, where the electrolyte layer is sandwiched between an anode layer and a cathode layer, where each can be formed from sintered particulate materials such as described herein.

In certain embodiments, the electrolyte layer can be the first layer formed in the structure of an MS-SOC. In such a case, the electrolyte layer can be formed on a variety of substrates having the appropriate properties, for example, Mylar film, silicon coated Mylar film, glass or Kapton.

In some embodiments, the ultra-thin ceramic electrochemical assembly further includes a barrier layer disposed on the electrolyte layer. In certain embodiments, the barrier layer includes, for example, a PrₓGd_{y}Ce_{z}O_{1.9-δ} composition, where x is 0.1 to 0.3, y is 0.1 to 0.3 and z is 0.5 to 0.8 such as a Pr_{0.1}Gd_{0.1}Ce_{0.8}O_{1.9-δ} composition. The barrier layer can be tested for uniformity and composition using energy-dispersive X-ray spectroscopy (EDX) and X-ray diffraction (XRD).

In various embodiments, the porous metallic support includes a stainless steel sheet fabricated into a porous structure. In some embodiments, the thickness of the porous metallic support can be between 50 micrometers and 250 micrometers. For example, the thickness can be between 50 micrometers to 250 micrometers, 75 micrometers to 225 micrometers, 100 micrometers to 200 micrometers, 125 micrometers to 175 micrometers, 50 micrometers to 75 micrometers, 75 micrometers to 100 micrometers, 100 micrometers to 125 micrometers, 125 micrometers to 150 micrometers, 150 micrometers to 175 micrometers, 175 micrometers to 200 micrometers, 200 micrometers to 225 micrometers, and 225 micrometers to 250 micrometers. In further embodiments, the thickness of the porous metallic support can be 50 micrometers to 75 micrometers, 75 micrometers to 100 micrometers, 100 micrometers to 125 micrometers, 125 micrometers to 150 micrometers, 150 micrometers to 175 micrometers, 175 micrometers to 200 micrometers, 200 micrometers to 225 micrometers, or 225 micrometers to 250 micrometers. These measurements can be determined by micrometer caliper measurements. In addition, mechanical strength testing such as three-point bending tests can be conducted on the porous metallic support.

Electrically conductive metal bonding layers suitable for binding a porous metallic substrate to an anode support layer or an anode layer of an ultra-thin ceramic electrochemical cell include silver, which provides very high electrical conductivity, good ductility, and reliable compliance with thermal expansion mismatch while remaining stable in typical cell operating environments. Copper is also suitable due to its excellent electrical conductivity and strong metallurgical bonding to metallic substrates, particularly when used with appropriate diffusion barriers to control interfacial reactions. Gold offers outstanding oxidation resistance and electrical performance and is especially advantageous in chemically aggressive environments, although its use is typically limited by cost.

Nickel is particularly well suited for this application because it is chemically and thermally compatible with many ceramic anode materials, especially nickel-based cermet anodes, and it maintains good electrical conductivity under reducing conditions. Palladium is another effective bonding layer, combining high electrical conductivity with excellent adhesion to both metals and ceramic oxides, and offering enhanced stability at elevated temperatures.

Silver copper alloys with active metal additions are also highly effective bonding layers, as they provide a combination of high electrical conductivity, controlled melting behavior, and improved wetting of ceramic surfaces. Titanium-containing metallic bonding layers are well suited due to titanium's strong affinity for oxygen, which promotes chemical bonding to ceramic oxides while maintaining electrical continuity across the interface.

Chromium and molybdenum are well suited as conductive bonding or interfacial layers where high-temperature stability and controlled interdiffusion are required, particularly in multilayer architectures that must maintain electrical conductivity while suppressing deleterious reactions. Tantalum is similarly effective in demanding thermal environments due to its chemical stability and ability to form adherent interfaces with both metallic and ceramic materials. In certain embodiments, the electrically conductive bonding layer includes a nickel-based binder.

Cobalt is used in some systems because it offers good electrical conductivity and strong adhesion to both metallic substrates and ceramic oxides, with thermal expansion behavior similar to nickel. Iron and iron-based alloys are also used in certain designs, especially where cost and compatibility with ferritic stainless steel substrates are important, provided that oxidation and interdiffusion are carefully managed.

Platinum is occasionally used as a bonding or interfacial layer due to its excellent electrical conductivity, chemical inertness, and stability in both oxidizing and reducing environments, although its high cost generally limits its use to very thin layers. Ruthenium and iridium have also been investigated for specialized applications because of their high melting points, oxidation resistance, and good electrical properties at elevated temperatures.

Nickel chromium alloys are widely used where improved oxidation resistance and mechanical strength are required while maintaining electrical conductivity, particularly in multilayer bonding stacks. Cobalt chromium and iron chromium alloys serve similar functions, offering a balance of conductivity, thermal stability, and resistance to corrosion or scale formation.

Finally, refractory metals such as niobium and rhenium have been explored for high-temperature bonding applications due to their excellent thermal stability and electrical conductivity, typically as thin interlayers or components of multilayer systems rather than bulk bonding layers. These materials are especially useful when long-term stability at extreme operating temperatures is a primary design constraint. Alloys of two or more of the foregoing metals may be used in the porous metallic substrate.

In various embodiments, the bonding layer can be tested for electrical conductivity using four-point probe measurements and for adhesion using peel tests.

In some embodiments, the porous electrode structures include an anode support layer and a cathode layer disposed on opposite sides of the ultra-thin ceramic electrochemical assembly. In certain embodiments, the anode layer includes nickel oxide and a ceramic oxide that matches the coefficient of thermal expansion of the electrolyte layer composition. The coefficient of thermal expansion can be verified by thermomechanical analysis (TMA) and XRD.

In various embodiments, the cathode layer includes a perovskite-type oxide selected from lanthanum strontium manganite, lanthanum strontium cobalt ferrite, or barium strontium cobalt ferrite. In some embodiments, the cathode layer includes a Sm_{0.5}Sr_{0.5}CoO_{3-δ} (samarium strontium cobaltite)-Gd_{0.1}Ce_{0.9}O_{2-δ} (gadolinia-doped ceria) (SSC-GDC) composition. Here, δ represents the oxygen non-stoichiometry associated with oxygen vacancy formation in the respective oxide lattices. The value of δ is variable and depends on temperature, oxygen partial pressure, and material composition. In certain embodiments, δ may range from 0 to about 0.5, although other values may occur depending on operating conditions. The metal stoichiometries (e.g., Sm_{0.5}Sr_{0.5} and Gd_{0.1}Ce_{0.9}) represent example compositions and may vary within ranges sufficient to maintain the desired crystal structure and electrochemical functionality.

The difference between O₃-δ and O₂-δ reflects the underlying crystal structures of the respective materials. Perovskite-type oxides (e.g., Sm_{0.5}Sr_{0.5}CoO_{3-δ}) generally adopt an ABO₃ structure, whereas fluorite-type oxides (e.g., Gd_{0.1}Ce_{0.9}O_{2-δ}) adopt an AO₂ structure. The oxygen stoichiometry corresponds to the crystallographic structure of each phase. In certain embodiments, the cathode layer may be characterized for phase purity using X-ray diffraction (XRD) and for electrochemical activity using cyclic voltammetry or other electrochemical techniques known in the art The cathode layer can be tested for phase purity and electrochemical activity using XRD and cyclic voltammetry.

In certain embodiments, the MS-SOC includes a current collector such as a screen-printed current collector, e.g., a Gd_{0.1}Ce_{0.9}O_{2-δ} (gadolinia-doped ceria) or a lanthanum strontium cobaltite (LSC) current collector disposed on the cathode. In various embodiments, the current collector can be tested for conductivity and uniformity using four-point probe and SEM imaging.

In some embodiments, the total thickness of the ultra-thin ceramic electrochemical assembly can be between 50 micrometers and 250 micrometers. For example, the thickness can be between 50 micrometers to 250 micrometers, 75 micrometers to 225 micrometers, 100 micrometers to 200 micrometers, 125 micrometers to 175 micrometers, 50 micrometers to 75 micrometers, 75 micrometers to 100 micrometers, 100 micrometers to 125 micrometers, 125 micrometers to 150 micrometers, 150 micrometers to 175 micrometers, 175 micrometers to 200 micrometers, 200 micrometers to 225 micrometers, and 225 micrometers to 250 micrometers. In some embodiments, the total thickness of the ultra-thin ceramic electrochemical assembly can be 50 micrometers to 75 micrometers, 75 micrometers to 100 micrometers, 100 micrometers to 125 micrometers, 125 micrometers to 150 micrometers, 150 micrometers to 175 micrometers, 175 micrometers to 200 micrometers, 200 micrometers to 225 micrometers, or 225 micrometers to 250 micrometers. In certain embodiments, the thickness can be 100, 110, 120, 130, 140, 150, 160, 170, 180, 190, or 200 micrometers, The thickness of the ultra-thin ceramic electrochemical assembly can be measured by SEM and/or micrometer caliper.

In various embodiments, the metal-supported solid oxide electrochemical cell can exhibit a power density greater than 1.5 W/cm² at 0.9 V. In some embodiments, the metal-supported solid oxide electrochemical cell can exhibit a power density greater than 2.0 W/cm² at 0.9 V. In certain embodiments, the metal-supported solid oxide electrochemical cell can exhibit a power density greater than 2.5 W/cm² at 0.9 V. In particular embodiments, the metal-supported solid oxide electrochemical cell can exhibit a power density greater than 3.0 W/cm² at 0.9 V. The power density can be determined using current-voltage (I-V) curve measurements and electrochemical impedance spectroscopy (EIS).

The electrodes of the present disclosure can include an anode, such as an anode layer, which can be an ultra-thin anode layer. The anode particulates can be formed of one or more metal oxides selected gadolinium (Gd) oxide, cerium (Ce) oxide, yttrium (Y) oxide, scandium (Sc) oxide, zirconium (Zr) oxide, hafnium (Hf) oxide, niobium (Nb) oxide, tantalum (Ta) oxide, calcium (Ca) oxide, strontium (Sr) oxide, barium (Ba) oxide, praseodymium (Pr) oxide, neodymium (Nd) oxide, samarium (Sm) oxide, europium (Eu) oxide, gadolinium (Gd) oxide, terbium (Tb) oxide, dysprosium (Dy) oxide, holmium (Ho) oxide, erbium (Er) oxide, thulium (Tm) oxide, and ytterbium (Yb) oxide. In various embodiments, an anode can include two metal oxides, two or more metal oxides, three metal oxides, three or more metal oxides, four metal oxides, four or more metal oxides, five metal oxides, or five or more metal oxides from this list.

In some embodiments, the anode particulate material includes nickel (Ni) oxide and another listed metal oxide solid solution. The metal oxide solid solution can share a common metal oxide with the electrolyte. For example, if YSZ is used as electrolyte, anode composition should be NiO and YSZ. If GDC is used as electrolyte, the anode composition should be NiO and GDC. If BCZYYb is used as electrolyte, the anode composition should be NiO and BCZYYb.

In various embodiments, the anode, when formed into a layer, can have a thickness of about 150 micrometers, or less, such as less than or equal to 145 micrometers, less than or equal to 140 micrometers, less than or equal to 135 micrometers, less than or equal to 130 micrometers, less than or equal to 125 micrometers, less than or equal to 120 micrometers, less than or equal to 115 micrometers, less than or equal to 110 micrometers, or less than or equal to 105 micrometers. In some embodiments, the anode layer has a thickness less than or equal to 100 micrometers, less than or equal to 95 micrometers, less than or equal to 90 micrometers, less than or equal to 85 micrometers, less than or equal to 80 micrometers, less than or equal to 75 micrometers, less than or equal to 70 micrometers, less than or equal to 65 micrometers, less than or equal to 60 micrometers, or less than or equal to 55 micrometers. In certain embodiments, an ultra-thin anode layer can have a thickness less than or equal to 50 micrometers, less than or equal to 45 micrometers, less than or equal to 40 micrometers, less than or equal to 35 micrometers, less than or equal to 30 micrometers, less than or equal to 25 micrometers, less than or equal to 20 micrometers, less than or equal to 15 micrometers, or less than or equal to 10 micrometers. In each of these examples with upper limits, the lower limit for the thickness of an anode layer, such as an ultra-thin anode layer, is at least about 0.5 micrometers, or at least about 1 micrometers, or at least about 2 micrometers.

In various embodiments, the anode layer can be integrated into a multi-layer solid oxide cell structure, where the anode layer is adjacent an electrolyte layer, opposite a cathode layer, where each can be formed from sintered particulate materials such as described herein.

In various embodiments, the anode can have a supporting layer, i.e., an anode supporting layer, which can be an ultra-thin anode supporting layer, adjacent to the anode layer to provide structural integrity to the device. The anode support layer provides mechanical strength and dimensional stability to the entire cell. Because the electrolyte (usually made of yttria-stabilized zirconia, YSZ) is ultra-thin, often less than 10 micrometers, it cannot sustain itself mechanically.

In certain embodiments, the solid oxide cell includes an anode support layer that provides both structural and electrochemical functionality to the cell. The anode support layer serves as a mechanically robust substrate upon which an anode layer, a dense thin electrolyte layer and a cathode layer can be formed, thereby imparting dimensional stability to the cell during fabrication and operation at elevated temperatures.

The anode support particulates can be formed of one or more metal oxides selected from gadolinium (Gd) oxide, cerium (Ce) oxide, yttrium (Y) oxide, scandium (Sc) oxide, zirconium (Zr) oxide, hafnium (Hf) oxide, niobium (Nb) oxide, tantalum (Ta) oxide, calcium (Ca) oxide, strontium (Sr) oxide, barium (Ba) oxide, praseodymium (Pr) oxide, neodymium (Nd) oxide, samarium (Sm) oxide, europium (Eu) oxide, gadolinium (Gd) oxide, terbium (Tb) oxide, dysprosium (Dy) oxide, holmium (Ho) oxide, erbium (Er) oxide, thulium (Tm) oxide, and ytterbium (Yb) oxide. In various embodiments, the anode support particulates can include two metal oxides, two or more metal oxides, three metal oxides, three or more metal oxides, four metal oxides, four or more metal oxides, five metal oxides, or five or more metal oxides from this list.

In some embodiments, an anode supporting particulate material, when formed into a layer, i.e., an anode supporting layer, can have a thickness of about 150 micrometers, or less, such as less than or equal to 145 micrometers, less than or equal to 140 micrometers, less than or equal to 135 micrometers, less than or equal to 130 micrometers, less than or equal to 125 micrometers, less than or equal to 120 micrometers, less than or equal to 115 micrometers, less than or equal to 110 micrometers, or less than or equal to 105 micrometers. In some embodiments, the anode supporting layer has a thickness less than or equal to 100 micrometers, less than or equal to 95 micrometers, less than or equal to 90 micrometers, less than or equal to 85 micrometers, less than or equal to 80 micrometers, less than or equal to 75 micrometers, less than or equal to 70 micrometers, less than or equal to 65 micrometers, less than or equal to 60 micrometers, or less than or equal to 55 micrometers. In certain embodiments, an ultra-thin anode supporting layer can have a thickness less than or equal to 50 micrometers, less than or equal to 45 micrometers, less than or equal to 40 micrometers, less than or equal to 35 micrometers, less than or equal to 30 micrometers, less than or equal to 25 micrometers, less than or equal to 20 micrometers, less than or equal to 15 micrometers, or less than or equal to 10 micrometers. In each of these examples with upper limits, the lower limit for the thickness of an anode supporting layer, such as an ultra-thin anode supporting layer, is at least about 0.5 micrometers, or at least about 1 micrometers, or at least about 2 micrometers.

In various embodiments, the anode supporting layer can be integrated into a multi-layer solid oxide cell structure, where the anode supporting layer is adjacent an anode layer, opposite an electrolyte layer as shown in FIG. 1, where anode supporting layer 28 is adjacent the anode 14, which has an electrolyte 24 on its opposite face. Each of these layers can be formed from sintered particulate materials such as described herein.

The electrodes of the present disclosure can include a cathode, such as a cathode layer, which can be an ultra-thin cathode layer. The cathode particulates can be formed of one or more metals selected from perovskite-type oxides. In some embodiments, the cathode particulates include metal oxides selected from the group consisting of nickel (Ni) oxide, nickel oxide-based cermets, strontium (Sr) oxide, lanthanum (La) oxide, manganese (Mn) oxide, cobalt (Co) oxide, iron (Fe) oxide, zinc (Zn) oxide, praseodymium (Pr) oxide, barium (Ba) oxide, gadolinium (Gd) oxide, and samarium (Sm) oxide. These elements can be incorporated in various combinations to form advanced oxide materials such as strontium-doped lanthanum manganite (LSM), lanthanum strontium cobalt ferrite (LSCF), lanthanum strontium iron manganese cobalt oxide (LSFMC), lanthanum strontium zinc iron oxide (LSZF), praseodymium barium strontium cobalt iron oxide (PBSCF), lanthanum strontium cobaltite (LSC), barium strontium cobalt ferrite (BSCF), gadolinium doped ceria, and samarium doped ceria (GDC/SDC). The selection and combination of these elements enable the tailoring of electrical, ionic, and catalytic properties for specific applications in solid oxide cells and related devices.

In various embodiments, the cathode, when formed into a layer, can have a thickness of about 150 micrometers, or less, such as less than or equal to 145 micrometers, less than or equal to 140 micrometers, less than or equal to 135 micrometers, less than or equal to 130 micrometers, less than or equal to 125 micrometers, less than or equal to 120 micrometers, less than or equal to 115 micrometers, less than or equal to 110 micrometers, or less than or equal to 105 micrometers. In some embodiments, the cathode layer has a thickness less than or equal to 100 micrometers, less than or equal to 95 micrometers, less than or equal to 90 micrometers, less than or equal to 85 micrometers, less than or equal to 80 micrometers, less than or equal to 75 micrometers, less than or equal to 70 micrometers, less than or equal to 65 micrometers, less than or equal to 60 micrometers, or less than or equal to 55 micrometers. In certain embodiments, an ultra-thin cathode layer can have a thickness less than or equal to 50 micrometers, less than or equal to 45 micrometers, less than or equal to 40 micrometers, less than or equal to 35 micrometers, less than or equal to 30 micrometers, less than or equal to 25 micrometers, less than or equal to 20 micrometers, less than or equal to 15 micrometers, or less than or equal to 10 micrometers. In each of these examples with upper limits, the lower limit for the thickness of a cathode layer, such as an ultra-thin cathode layer, is at least about 0.5 micrometers, or at least about 1 micrometers, or at least about 2 micrometers.

The cathode layer can be directly adjacent to the electrolyte, or to a barrier layer applied to the electrolyte, for example, sintered electrolyte particulates, to assist in the electrochemical conversion process. In certain embodiments, the present disclosure includes an ultra-thin barrier (or buffer) layer, which can include gadolinium doped ceria (GDC) and/or praseodymium and gadolinium co-doped ceria (PGCO). This layer can be applied in various ways including, but not limited to, printing the barrier layer. In various embodiments, with reference to FIG. 1, the cathode layer can be integrated into a MS-SOC 10, where the cathode layer 16 is adjacent an electrolyte layer 24 (with a barrier layer 22 in-between), opposite an anode layer 14.

In certain embodiments, the present disclosure provides a device that includes at least one metal-supported solid oxide electrochemical cell. In various embodiments, the device can be a fuel cell stack, a portable power generator, an aviation power system, a maritime propulsion system, a data center backup power system, or a hybrid energy system.

### Methods of Making Ultra-Thin Solid Oxide Cells

In another aspect, the present disclosure provides methods of making the ultra-thin MS-SOCs described herein. That is, the present disclosure also describes a method of manufacturing and assembling the electrolyte with the electrodes to form a multilayered MS-SOC and adding the porous metal support to form the MS-SOC.

More specifically, methods of making the metal-supported solid oxide electrochemical cells described herein include preparing slurries of the electrolyte layer, anode active layer, and anode supporting layer using Resonant Acoustic Mixing® (RAM), followed by sequential layer casting onto a carrier and a two-step sintering process to achieve controlled shrinkage and final density. A barrier layer ink can be screen-printed onto the sintered electrolyte surface and fired, followed by screen-printing and sintering of the cathode and current collector layers. Subsequently, a metal-based binder can be applied to the porous metallic support before positioning the pre-fabricated ceramic assembly to complete the MS-SOC.

In particular, the methods of making the electrolytes and electrodes described herein include processing, for example, mixing, the components of the slurry preparation of a particular electrolyte or electrode layer, for example, an electrolyte layer, or an anode layer, or an anode support layer, or a barrier layer, or a cathode layer using acoustic energy such as Resonant Acoustic® Mixing (“RAM”) from Resodyn Corporation, Butte, Montana. Generally, RAM is a bladeless mixing technology that uses sound energy and resonance to mix materials without mechanical means. RAM uses low-frequency, high-intensity acoustic energy and high acceleration to mix powders quickly, thoroughly, and accurately. RAM can also be advantageously used to defoam and/or de-aerate mixtures, for example, slurries, particularly after mixing.

Accordingly, in methods of fabricating a MS-SOC according to the present disclosure, the methods can generally include mixing a dispersant in a solvent using low-frequency, high-intensity acoustic energy and high acceleration such as generated by RAM, to ensure uniform dispersion. The appropriate particulates (e.g., electrolyte particulates, anode particulates, anode support particulates, or cathode particulates), a plasticizer, and a binder can then be added to the mixture in sequence with RAM applied for a predetermined amount of time after each addition. The combined materials can be further mixed using RAM to produce the respective homogeneous slurry. This slurry can be subsequently degassed to remove any entrapped air or gases. The de-gassed slurry can be cast to form an electrolyte layer, an anode layer, an anode support layer, or a cathode layer which can be in an ultra-thin format. Each layer can be disposed one atop the other in the desired sequence to form the MS-SOC. For example, the anode layer can be disposed on one surface of the electrolyte layer, while the cathode layer can be disposed on an opposing surface of the electrolyte layer to form a MS-SOC.

The amount of solvent in electrolyte and electrode slurries is a formulation parameter that can affect slurry viscosity, coating quality, drying behavior, and ultimately electrode microstructure. The solvent serves primarily to dissolve or disperse the binder and to create a workable suspension of the active particulate material and any additives. After the slurry is coated onto the appropriate substrate, which could be another layer of the MS-SOC, the solvent is evaporated, leaving behind the solid electrode film.

Solvents that are useful in the practice of the present teaching include liquid aprotic polar solvents such as water, propylene carbonate, ethylene carbonate, butyrolactone, acetonitrile, benzonitrile, nitromethane, nitrobenzene, sulfolane, dimethylformamide, N-methylpyrrolidone, or the like, or combinations includes at least one of the foregoing solvents. Polar protic solvents such as, but not limited to, water, methanol, acetonitrile, nitromethane, ethanol, propanol, isopropanol, butanol, or the like, or combinations includes at least one of the foregoing polar protic solvents can be used. Other non-polar solvents such as benzene, toluene, xylene, methylene chloride, carbon tetrachloride, hexane, diethyl ether, tetrahydrofuran, methyl ethyl ketone, or the like, or combinations includes at least one of the foregoing solvents can also be used. Co-solvents includes at least one aprotic polar solvent and at least one non-polar solvent can also be used.

In general, electrolyte and electrode slurries contain about 30% to about 60% solids, which means the solvent fraction typically makes up about 40% to about 70% of the total slurry mass. The exact ratio depends on several factors, including the viscosity of the binder solution, particle size distribution, mixing parameters, and the desired coating thickness.

In the preparation of electrolyte and electrode layers for electrochemical devices, binders (e.g., polymers) can play a role in determining both the mechanical integrity and the electrochemical performance of the final electrode. These polymers are incorporated into the slurry mixture along with active material particles and conductive additives to provide cohesion within the electrode film and adhesion to the current collector surface.

Binders can include polymers such as organic polymers and can be selected from a wide variety of thermoplastic polymers, blend of thermoplastic polymers, thermosetting polymers, or blends of thermoplastic polymers with thermosetting polymers. The organic polymer can also be a blend of polymers, copolymers, terpolymers, or combinations includes at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination includes at last one of the foregoing organic polymers. The organic polymers have number average molecular weights greater than 10,000 grams per mole, preferably greater than 20,000 g/mole and more preferably greater than 50,000 g/mole.

Examples of thermoplastic polymers include a polyacrylic, a polycarbonate, a polyalkyd, a polystyrene, a polyolefin, a polyester, a polyamide, a polyaramid, a polyamideimide, a polyarylate, a polyurethane, an epoxy, a phenolic, a polysiloxane, a polyarylsulfone, a polyethersulfone, a polyphenylene sulfide, a polysulfone, a polyimide, a polyetherimide, a polytetrafluoroethylene, a polyetherketone, a polyether ether ketone, a polyether ketone, a polybenzoxazole, a polyoxadiazole, a polybenzothiazole, a polybenzothiazinophenothiazine, a polypyrazinoquinoxaline, a polypyromellitimide, a polyguinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyolefin, or the like, or a combination thereof.

Other examples of the organic polymers that can be used as binders or include polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polyethylene terephthalate, polybutylene terephthalate, polyurethane, polytetrafluoroethylene, perfluoroelastomers, fluorinated ethylene propylene, perfluoroalkoxyethylene, polychlorotrifluoroethylene, polyvinylidene fluoride, polysiloxanes, or the like, or a combination includes at least one of the foregoing organic polymers.

Typically, binder content ranges from about 0.5% to about 20% or about 15% or about 10% of the total solids in the slurry. Using too little binder can lead to cracking or delamination of the electrode film, whereas excess binder can reduce electrical conductivity and limit the amount of active material that can be loaded. Recent research has also focused on bio-based binders (such as alginate and chitosan) and conductive polymer binders (such as PEDOT:PSS and polypyrrole), which offer greener processing or improved electronic pathways. In all cases, the binder must strike a delicate balance between mechanical, chemical, and electrochemical properties, ensuring both processability and stable long-term performance of the electrode. Properties of the binder such as surface area, particle size, and density should be considered when determining the appropriate amount for a particular application.

In electrolyte and electrode slurry formulation, plasticizers are additives used to improve the flexibility, processability, and mechanical stability of the electrode film. While binders provide cohesion and adhesion, plasticizers modify the physical properties of the binder matrix-reducing brittleness, improving film formation, and enhancing coating uniformity. They work by intercalating between polymer chains, increasing molecular mobility and lowering the glass transition temperature (Tg) of the polymer, which makes the dried electrode film less prone to cracking or delamination during drying and cycling.

Plasticizers can include ethylene carbonate (EC), dimethyl carbonate (DMC), propylene carbonate (PC), succinonitrile (SN), and certain ionic liquids (for example, 1-ethyl-3-methylimidazolium bis(trifluoromethylsulfonyl)imide, or EMIM-TFSI). Emerging research also explores bio-based plasticizers such as triacetin, glycerol triacetate, and citric acid esters, which offer improved safety, lower volatility, and better environmental compatibility.

Typically, plasticizers are added in small proportions, usually about 1% to about 10% of the total solid or polymer content. Too little plasticizer can lead to brittle, cracked electrodes, while too much can cause film softening, poor adhesion, or leaching during cycling. Recent trends include the use of eco-friendly plasticizers, such as bio-based esters and ionic liquids, to replace conventional phthalates and improve sustainability and safety in electrode manufacturing. The amount of plasticizer needs to be adjusted based on the above and the particular application of the product.

Dispersants are additives used in electrolyte and electrode slurries and other particulate suspensions to prevent agglomeration and maintain uniform distribution of solids. A wide range of dispersants can be used depending on the material system and solvent.

Dispersants can include polymeric dispersants such as described herein, including polyacrylic acid (PAA), polyacrylates, polycarboxylates, and polyethylene oxide-polypropylene oxide block copolymers, which stabilize particles through steric hindrance. Surfactant-based dispersants include small molecules such as sodium dodecyl sulfate (SDS), sodium hexametaphosphate, alkylbenzene sulfonates, and phosphate esters, which stabilize particles via electrostatic or electro-steric mechanisms. Some dispersants combine polymeric backbones with functional groups that provide both steric and electrostatic stabilization, such as graft copolymers and comb-shaped polymers commonly used in high-solids slurries for inks, paints, and battery electrodes. In aqueous systems, CMC (carboxymethyl cellulose) and sodium polyacrylate also serve dual roles as dispersants and rheology modifiers, enhancing particle dispersion while controlling slurry viscosity. Emerging research has introduced bio-based dispersants, including alginate derivatives and modified polysaccharides, which offer environmentally friendly alternatives for both aqueous and organic solvent systems. Overall, the choice of dispersant depends on particle type, solvent, desired stability, and the specific application, balancing electrostatic, steric, and chemical compatibility considerations.

In electrolyte and electrode slurries, the dispersant content is typically much lower than that of the active material, binder, or solvent, but it plays a crucial role in maintaining particle stability and uniformity. Generally, dispersants can be used in the range of about 0.5% to about 5% relative to the total solids in the slurry, though the exact amount can depend on the particle type, surface chemistry, solvent system, and solids loading.

In various embodiments, the electrolyte slurry can include about 20% to about 80% metal oxides, about 2% to about 8% binder, about 1% to about 4% plasticizer, and about 0.01% to about 0.1% dispersant, based on the total weight of the slurry. In some embodiments, the anode slurry can include about 45% to about 75% metal oxides, about 1% to about 10% binder, about 1% to about 5% plasticizer, and about 0.5% to about 4% dispersant, based on the total weight of the slurry. In certain embodiments, the cathode slurry can include about 35% to about 65% metal oxides, about 2% to about 9% binder, about 0.05% to about 1% plasticizer, and about 30% to about 60% dispersant, based on the total weight of the slurry. In particular embodiments, the anode support slurry can include about 25% to about 65% metal oxides, about 1% to about 5% binder, about 15% to about 35% pore former, about 1% to about 5% plasticizer, and about 0.05% to about 4% dispersant, based on the total weight of the slurry.

Reference is now made to Example 1, which contains a more detailed description of the fabrication of an MS-SOC according to the present disclosure.

### Methods of Using Ultra-Thin Solid Oxide Cells

In yet another aspect, the present disclosure provides methods of using the MS-SOCs described herein.

In some embodiments, the methods include flowing an electrical current through the ultra-thin ceramic electrochemical assembly, with the anode supplied with (humidified) hydrogen and the cathode fed with air, enabling electrochemical measurements such as impedance spectroscopy and current-voltage characterization. In certain embodiments, the cells are integrated into devices selected from fuel cell stacks, portable power generators, aviation power systems, maritime propulsion systems, data center backup power systems, and hybrid energy systems. In particular embodiments, the ultra-thin configuration and robust mechanical strength of the cells facilitate their use in compact, lightweight, and portable applications, overcoming the limitations of conventional fabrication techniques and cell architectures

In use, an MS-SOC can be operated by flowing an electrical current through the cell to facilitate energy conversion or storage processes. The MS-SOC can be incorporated into various articles of manufacture, such as batteries, fuel cells, or electrolyzers, depending on the desired application. During operation, the MS-SOC can function as a fuel cell to generate electricity from chemical fuels, as an electrolyzer to produce chemical products through electrolysis, or as a component in energy storage devices to store and release electrical energy as needed. The method of using the MS-SOC can include connecting the cell to an external electrical circuit, supplying reactants or electrolytes as appropriate for the specific device, and controlling the operating conditions such as temperature, pressure, and current flow to optimize performance and efficiency. The versatility of the MS-SOC allows the solid oxide cell to be adapted for a wide range of energy conversion and storage applications, providing reliable operation in various environments and system configurations.

Accordingly, in certain embodiments, the MS-SOCs as described herein can be incorporated into a solid oxide fuel cell (SOFC). More specifically, a SOFC can include a metal-supported solid oxide electrochemical cell including an ultra-thin ceramic electrochemical assembly disposed between porous electrode structures. The ultra-thin ceramic electrochemical assembly can include an electrolyte layer; an unsintered, porous metallic support; and an electrically conductive bonding layer interposed between the unsintered, porous metallic support and the ultra-thin ceramic electrochemical assembly. The electrolyte layer can have a thickness of 0.1 micrometer to 10 micrometers. The SOFC also can include a source of fuel in fluid communication with the anode layer of the MS-SOC; and a source of air in fluid communication with the cathode layer of the MS-SOC.

With reference to FIG. 1B, an exemplary SOFC 50 includes a SOC Stack 52, which incorporates the MS-SOC 10′ therein. In operation, a source of fuel 52, for example, hydrocarbons and/or CO, is in fluid communication with the anode layer (not shown) of the MS-SOC 10′. The fuel typically is first pretreated in a pretreatment reactor 54, for example, to clean the fuel of sulfur and other contaminants before reforming into hydrogen. After pretreatment, the fuel can be exposed to a pre-heater and reformer 56, and then introduced to an anode side inlet 58 of the SOC Stack 52.

For the cathode side of the MS-SOC, a source of air 60 is in fluid communication with the cathode layer (not shown) of the MS-SOC 10′. The air usually flows through a heat exchanger 62 and then is introduced to a cathode side inlet 64 of the SOC Stack 52. During operation of the SOFC, electricity is produced. The current produced by the MS-SOC can flow through an AC/DC converter 66 then out of the SOFC as electricity 68 for use.

Finally, the heated exhaust from the SOC Stack 52 can be routed through an Burner or afterburner 70 to combust unused fuel and other components. The heat flow from the afterburner can be circulated for use to heat the fuel passing through the pre-heater and reformer 56 as well as incoming air via the heat exchanger 62.

A variety of devices may make use of the MS-SOC introduced herein. For example, wearable electronics such as smartwatches, fitness trackers, and other items where a slim, lightweight power source complements ergonomic designs. Medical implants or sensors such as implantable devices, remote physiological sensors, or patch-based monitors that benefit from thin, biocompatible power sources. Smart cards or ID badges such as cards that require an embedded power supply for memory or secure authentication features without increasing overall thickness. Wireless sensor nodes such as low-power Internet of Things (IoT) devices positioned in inaccessible locations where compact, efficient energy storage is needed. Flexible displays and E-paper such as thin, bendable power cells that integrate seamlessly with rollable or foldable electronics, such as advanced e-paper screens.

Thin metal oxide energy storage cells are valued for high energy density, long cycle life, and low self-discharge. They support compact, reliable designs in fields where conventional bulk batteries are too large or heavy.

The electrical behavior allows incorporation of the solid oxide cell into energy-conversion and energy-storage apparatuses that require low internal resistance, stable performance, and compatibility with reversible operation. The structure supports fuel-cell operation that generates electrical energy and electrolyzer operation that stores electrical energy in chemical form.

Another apparatus can include a solid oxide electrolyzer configured to convert electrical energy into chemical energy by producing hydrogen, syngas, oxygen, or ammonia precursors. The ultra-thin electrolyte enables reduced ohmic losses, which increases the efficiency of high-temperature electrolysis when paired with renewable or off-peak electrical sources.

A further apparatus can incorporate the MS-SOC stack into a reversible solid-oxide energy-storage module. In this example, the stack operates as an electrolyzer during periods of excess electrical supply and as a fuel cell during periods of electrical demand. The combined system can store energy chemically in the form of hydrogen, carbon monoxide, methane, or other reduced products generated during electrolysis. The stored chemical stream can be reconverted to electrical energy through fuel-cell mode operation. Such a module can be used in support of grid-balancing services, long-duration storage installations, or hybrid renewable-energy systems.

A compact MS-SOC assembly also can be integrated into portable power units, industrial backup power systems, or remote instrumentation packages where the rapid manufacturing approach reduces cost and increases reliability. The thin-film electrolyte structures described herein provide for high power density in a small footprint, enabling deployment in environments with weight or volume constraints.

### EXAMPLE

### Example 1. Fabrication of an Exemplary Ultra-Thin Solid Oxide Electrochemical Cell (MS-SOC)

Preparation of ceramic layer. The slurries of the electrolyte layer, anode active layer and the anode supporting layer were prepared using Resonant Acoustic Mixing® (RAM). The amounts of materials and their ratios are as described herein. The entire process, which consists of mixing (adding pore former), dispersion, coagulation, and plasticization, is completed in a total of 25 minutes. Subsequently, these slurries were sequentially cast layer by layer onto a Mylar carrier using a doctor blade setup.

Generally, RAM introduces controlled acoustic energy at a selected frequency. An external driver induces oscillatory motion in a sealed container. The container transmits forces to materials. The materials reach a fluidized state. The final blend achieves uniform dispersion. For example: a manufacturer places epoxy resin and powdered filler in a metal can. A resonant acoustic driver secures the can at a chosen frequency. The induced oscillation fluidizes the resin and filler. The dispersed filler produces a consistent composite. Similar processes include ultrasonic agitation, high-frequency rotary blending, and rapid pneumatic shaking. Equipment specifications and container size limit the resonant acoustic approach. The process may increase frictional heat in dense mixtures. After the RAM, sintering is performed.

Sintering procedure. A two-step sintering approach was developed to ensure the organic components are burnt out before the ceramic materials sintered together with controlled shrinkage rate and final sintering density to avoid severe warping and part broken. The pre-sintering step is conducted in a box furnace with the sintering temperature up to 1080° C. The final sintering step is to bring the parts to a flat and mechanically strong form with fully dense YSZ layer and proper densities of anode support layer and active function layer. To do so, the pre-sintered samples were added proper alumina or zirconia weights and heated to 1350 to 1375° C.

Preparation of barrier and cathode. In one embodiment, the barrier layer used Pr_{0.1}Gd_{0.1}Ce_{0.8}O_{1.9-δ}. The barrier layer ink was screen-printed on the sintered YSZ surface and then fired at 1200 degrees Celsius for 3 hours. Then, the SSC-GDC cathode was screen-printed on the surface of the barrier layer and sintered at 1000 degrees Celsius for 2 hours. Final, the LSC current collector was screen-printed on the cathode surface and sintered at 1000 degrees Celsius for 1 hour.

Preparation of MS-SOC. A stainless steel sheet was fabricated into a porous structure. In this example, a Ni-based binder was applied to the porous stainless steel sheet. The as-prepared SOC was positioned on the stainless steel substrate to complete the fabrication of the MS-SOC.

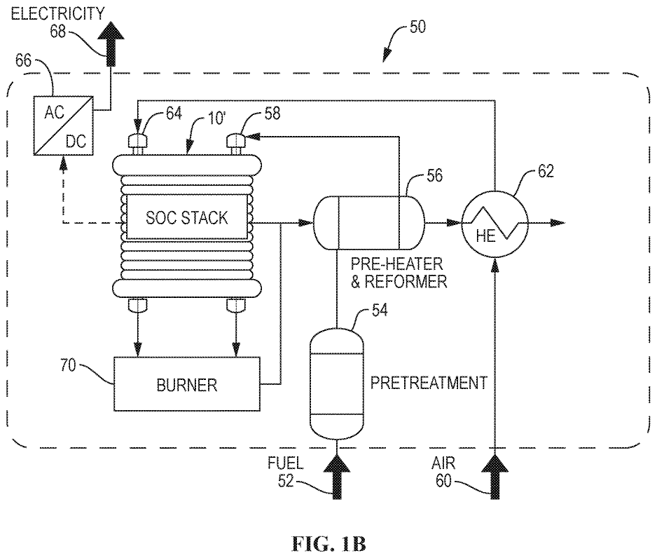

Physical Analysis. The products were examined with SEM to validate the thickness, structure, and porosity of the different layers during construction and after completion. FIG. 2 illustrates the cross-sectional structure of the metal-supported solid oxide cell, highlighting the arrangement and interaction of the layers within the cell. The ultra-thin ceramic electrochemical assembly comprises the dense YSZ electrolyte, the PGCO barrier layer, and the AFL, positioned between the porous electrode structures. The cathode side incorporates the GDC/SSC cathode and the LSC current collector, while the anode side includes the anode and AFL. The Ni paste forms the electrically conductive bonding layer, connecting the ceramic assembly to the porous metal support, which contributes to mechanical strength and compatibility. The interfaces between the cathode, barrier, electrolyte, anode, bonding layer, and metal support are configured to enhance ionic and electronic transport, chemical stability, and structural integrity within the MS-SOC.

MS-SOC electrochemical measurements. MS-SOCs fabricated according to the methods described herein were evaluated and tested using various techniques as described below with reference to the figures. The SOFC cell performance was evaluated using a high temperature test station equipped with controlled gas flows at different temperatures with a potentiostat.

The cells were electrically connected to Pt wires in a 4-probe configuration and sealed on an alumina tube with glass paste. A quarter-inch alumina tube was used to provide air flow to the cathode. The chamber of the sealed tube was purged with nitrogen before the NiO/YSZ anode was reduced by the hydrogen/nitrogen mixture for 1 hour. During electrochemical measurements, the Ni/YSZ anode was supplied with 3% humidified H₂ at a rate of 200 sccm and the cathode was fed with 400 sccm air. The electrochemical impedance spectrum (EIS) and current-voltage (i-V) curve was obtained by using a Biologic VMP3 multi-channel potentiostat (Bio-Logic USA, Knoxville, TN) equipped with external current boosters.

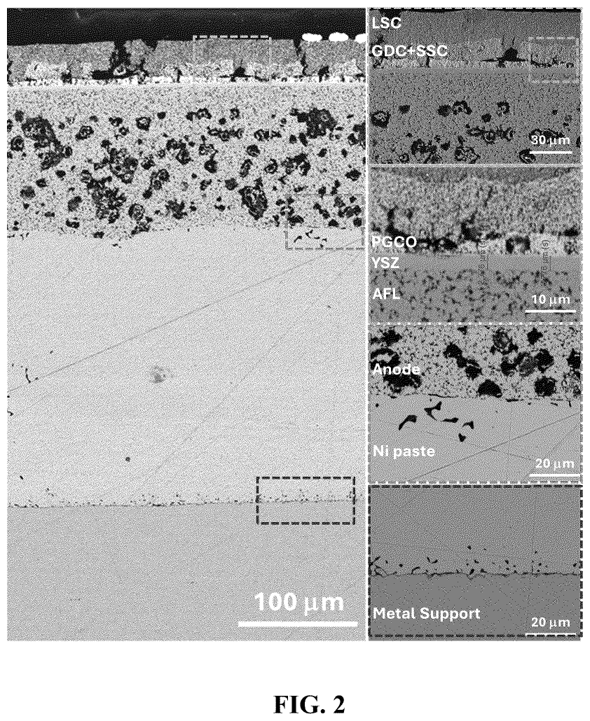

FIG. 3 illustrates the voltage and power density characteristics of a metal-supported solid oxide electrochemical cell under varying current densities at operating temperatures of 800° C., 750° C., and 700° C. The cell is supplied with air at 600 sccm and hydrogen at 200 sccm. The results demonstrate that higher operating temperatures yield increased power density and voltage, indicating enhanced cell performance and efficiency.

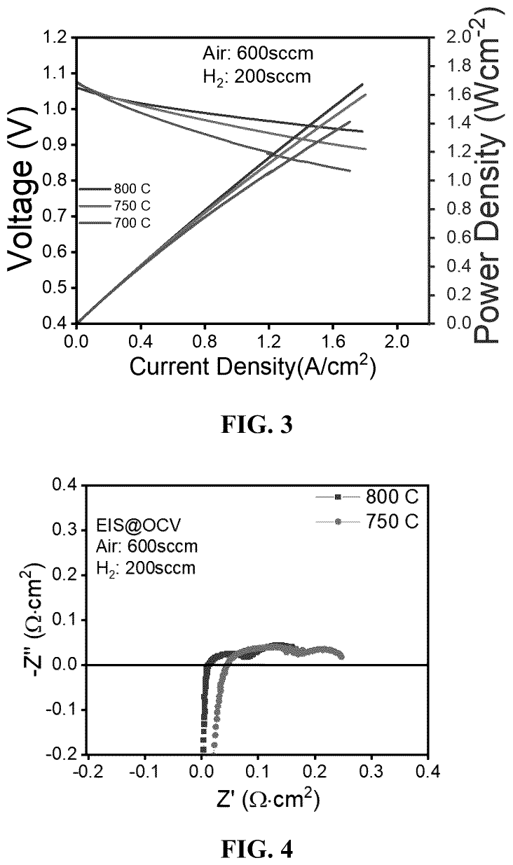

FIG. 4 presents electrochemical impedance spectroscopy (EIS) measurements at open circuit voltage for the cell at 800° C. and 750° C., with air and hydrogen flows identical to those in FIG. 3. The impedance spectra show reduced resistance at higher temperature, reflecting improved ionic transport and electrode kinetics.

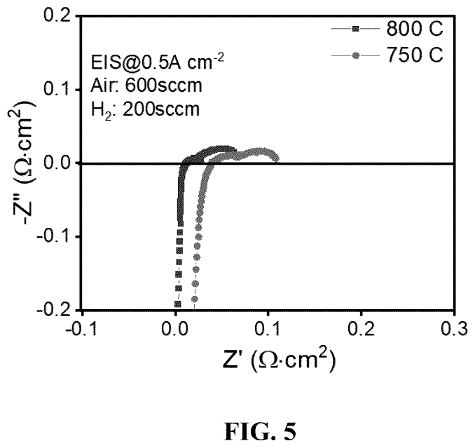

FIG. 5 shows EIS measurements at a current density of 0.5 A/cm² for the cell at 800° C. and 750° C., again with air at 600 sccm and hydrogen at 200 sccm. The impedance profiles confirm that operation at elevated temperature results in lower overall cell resistance, supporting superior electrochemical performance.

To facilitate an understanding of the present invention, a number of terms and phrases are defined below.

Unless defined otherwise, all technical and scientific terms used herein have the same meaning as commonly understood by one of ordinary skill in the art to which this invention belongs. The abbreviations used herein have their conventional meaning within the chemical and biological arts. The chemical structures and formulae set forth herein are constructed according to the standard rules of chemical valency known in the chemical arts.

The terms “a” and “an” as used herein mean “one or more” and include the plural unless the context is inappropriate.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular compound, that compound can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments can be variously combined or separated without parting from the present disclosure and invention(s). For example, it will be appreciated that all features described and depicted herein can be applicable to all aspects of the invention(s) described and depicted herein.

In other words, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the disclosure herein of any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Accordingly, any means which can provide those functionalities can be regarded as equivalent to those shown herein. No functional language used in claims appended herein is to be construed as invoking 35 U.S.C. § 112 (f) interpretations as “means-plus-function” language unless specifically expressed as such by use of the words “means for” or “steps for” within the respective claim.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise. As used herein, the term “about” refers to a ±10% variation, a ±5% variation, or a ±2.5% variation from the nominal value as understood from the context, unless otherwise indicated or inferred from the context.

At various places in the present specification, values are disclosed in groups or in ranges. It should be understood that the endpoints and each intervening integer value and each fraction thereof, as well as each subrange, between the recited endpoints (upper and lower limits) of that range are specifically disclosed. It is specifically intended that the description include each and every individual sub-combination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20, as well as the range of 1 to 17, and 3 to 19, and 5-8, as examples.

The use of any and all examples, or exemplary language herein, for example, “such as” or “including,” is intended merely to illustrate better the present invention and does not pose a limitation on the scope of the invention unless claimed. The examples provided herein are intended solely for illustrative purposes and are not to be interpreted as restricting the disclosed subject matter to the specific embodiments presented. No language in the specification should be construed as indicating any non-claimed element as essential to the practice of the present invention.

Throughout the description, where compositions and kits are described as having, including, or comprising specific components, or where processes and methods are described as having, including, or comprising specific steps, it is contemplated that, additionally, there are compositions and kits of the present invention that consist essentially of, or consist of, the recited components, and that there are processes and methods according to the present invention that consist essentially of, or consist of, the recited processing steps.

As a general matter, compositions specifying a percentage are by weight unless otherwise specified.

Any particular embodiment of the present disclosure that falls within the prior art can be explicitly excluded from any one or more of the claims. Because such embodiments are deemed to be known to one of ordinary skill in the art, they can be excluded even if the exclusion is not set forth explicitly herein. Any particular embodiment of the disclosure can be excluded from any claim, for any reason, whether or not related to the existence of prior art.

The disclosure can be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein.

What is claimed is:

1. A metal-supported solid oxide electrochemical cell comprising:
an ultra-thin ceramic electrochemical assembly disposed between porous electrode structures, wherein the ultra-thin ceramic electrochemical assembly comprises an electrolyte layer, the electrolyte layer having a thickness of 0.1 micrometer to 10 micrometers;
an unsintered, porous metallic support; and
an electrically conductive bonding layer interposed between the unsintered, porous metallic support and the ultra-thin ceramic electrochemical assembly.

2. The metal-supported solid oxide electrochemical cell of claim 1, wherein the electrolyte layer comprises a dense yttria-stabilized zirconia (YSZ).

3. The metal-supported solid oxide electrochemical cell of claim 2, wherein the dense YSZ electrolyte layer has a thickness of 2 micrometers to 8 micrometers.

4. The metal-supported solid oxide electrochemical cell of claim 1, wherein the ultra-thin ceramic electrochemical assembly further comprises a barrier layer disposed on the dense YSZ electrolyte layer.

5. The metal-supported solid oxide electrochemical cell of claim 4, wherein the barrier layer comprises a Pr_{0.05-0.3}Gd_{0.05-0.3}Ce_{0.7-0.9}O₂₋₈ barrier layer.

6. The metal-supported solid oxide electrochemical cell of claim 1, wherein the unsintered, porous metallic support comprises a porous stainless steel sheet.

7. The metal-supported solid oxide electrochemical cell of claim 1, wherein the electrically conductive bonding layer comprises a nickel-based binder.

8. The metal-supported solid oxide electrochemical cell of claim 1, wherein the porous electrode structures comprise an anode support layer and a cathode layer disposed on opposite sides of the ultra-thin ceramic electrochemical assembly.

9. The metal-supported solid oxide electrochemical cell of claim 8, further comprising an anode layer disposed on the anode support layer.

10. The metal-supported solid oxide electrochemical cell of claim 9, wherein the anode layer comprises nickel oxide and a ceramic oxide, the ceramic oxide being selected such that the anode layer exhibits a coefficient of thermal expansion substantially compatible with that of the electrolyte layer.

11. The metal-supported solid oxide electrochemical cell of claim 8, wherein the cathode layer comprises a perovskite-type oxide selected from lanthanum strontium manganite, lanthanum strontium cobalt ferrite, and barium strontium cobalt ferrite.

12. The metal-supported solid oxide electrochemical cell of claim 8, wherein the cathode layer comprises a Sm_{0.5}Sr_{0.5}CoO_{3-δ}—Gd_{0.1}Ce_{0.9}O_{2-δ} composition.

13. The metal-supported solid oxide electrochemical cell of claim 1, wherein the porous electrode structures comprise a Ni/YSZ anode.

14. The metal-supported solid oxide electrochemical cell of claim 1, wherein the cell further comprises a screen-printed current collector disposed on the cathode.

15. The metal-supported solid oxide electrochemical cell of claim 1, wherein the ultra-thin ceramic electrochemical assembly has a total thickness of 50 micrometers to 200 micrometers.

16. The metal-supported solid oxide electrochemical cell of claim 1, wherein the unsintered porous metallic support has a thickness of 50 micrometers to 200 micrometers.

17. The metal-supported solid oxide electrochemical cell of claim 1, wherein the metal-supported solid oxide electrochemical cell exhibits a power density greater than 1.5 W/cm² at 0.9 V.

18. A device comprising a metal-supported solid oxide electrochemical cell comprising:
an ultra-thin ceramic electrochemical assembly disposed between porous electrode structures, wherein the ultra-thin ceramic electrochemical assembly comprises an electrolyte layer, the electrolyte layer having a thickness of 0.1 micrometer to 10 micrometers;
an unsintered, porous metallic support; and
an electrically conductive bonding layer interposed between the unsintered, porous metallic support and the ultra-thin ceramic electrochemical assembly.

19. The device of claim 18, wherein the device is selected from the group consisting of a fuel cell stack, a portable power generator, an aviation power system, a maritime propulsion system, a data center backup power system, and a hybrid energy system.

20. A solid oxide fuel cell comprising:
a metal-supported solid oxide electrochemical cell comprising:
an ultra-thin ceramic electrochemical assembly disposed between porous electrode structures, wherein the ultra-thin ceramic electrochemical assembly comprises an electrolyte layer, the electrolyte layer having a thickness of 0.1 micrometer to 10 micrometers;
an unsintered, porous metallic support; and
an electrically conductive bonding layer interposed between the unsintered, porous metallic support and the ultra-thin ceramic electrochemical assembly;
a source of fuel in fluid communication with the anode layer; and
a source of air in fluid communication with the cathode layer.
